(19) United States
(12) Patent Application Publication
(10) Pub. No.: US 2020/0218992 A1
(43) Pub. Date: Jul. 9, 2020

(54) MULTI-FORECAST NETWORKS

(71) Applicants: Sony Corporation, Tokyo (JP); Sony Corporation of America, New York, NY (US)

(72) Inventors: Roberto Capobianco, Nicola di Pagnano (IT); Varun Kompella, Aachen (DE); Kaushik Subramanian, Richmond, CA (US); James Macglashan, Riverside, RI (US); Peter Wurman, Acton, MA (US); Satinder Baveja, Ann Arbor, MI (US)

(21) Appl. No.: 16/732,918

(22) Filed: Jan. 2, 2020

Related U.S. Application Data
(60) Provisional application No. 62/788,339, filed on Jan. 4, 2019.

(51) Int. Cl. G06N 5/02

(52) U.S. Cl. CPC G06N 5/02

(57) ABSTRACT

A method and system for training and/or operating an artificial intelligent agent can use multi-input and/or multi-forecast networks. Multi-forecasts are computational constructs, typically, but not necessarily, neural networks, whose shared network weights can be used to compute multiple related forecasts. This allows for more efficient training, in terms of the amount of data and/or experience needed, and in some instances, for more efficient computation of those forecasts. There are several related and sometimes composable approaches to multi-forecast networks.

### CROSS-REFERENCE TO RELATED APPLICATIONS

This application claims the benefit of priority to U.S. provisional patent application No. 62/788,339, filed Jan. 4, 2019, the contents of which are herein incorporated by reference.

### BACKGROUND OF THE INVENTION

### 1. Field of the Invention

One or more embodiments of the invention relates generally to intelligent artificial agents. More particularly, the invention relates to training an intelligent artificial agent through multi-forecasts and/or methods for making forecast computations more efficient.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Forecasts are predictions that are useful in many kinds of artificial intelligence (AI) systems. A forecast is a prediction of some outcome as a function of the world state and conditioned on a skill or behavior the agent executes. Forecasts can be used to make predictions about the outcome of a current behavior in a current state, or to make hypothetical predictions conditioned on hypothetical behavior for planning purposes. Examples of forecasts include the distance to the termination of some skill, the time to the termination of some skill, the value of a state feature at the time of termination of some skill, or the like.

Currently known systems for training artificial agents exhibit a variety of issues. In many cases, the user lacks the ability to control the skills and knowledge that are learned by the agent, or such learned skills and knowledge may be items that the user does not find to be as important as other desired skills and knowledge. Moreover, conventional systems may lack the ability to layer the skills and knowledge in a modular fashion to be used in learning higher level skills and knowledge. Also, in conventional systems, the artificial agent may not learn a specific form of knowledge, a prediction of features of experience during execution of a skill.

In view of the foregoing, there is need for improvements in the training of skills and knowledge in artificial intelligent agents.

### SUMMARY OF THE INVENTION

Embodiments of the present invention provide a multi-headed forecast method of creating artificial intelligence in machines and computer-based software applications, the method comprising receiving input from the environment as state information; and outputting a plurality of forecasts, each of the plurality of forecasts corresponding to a different state information feature.

Embodiments of the present invention further provide a multi-input forecast method of creating artificial intelligence in machines and computer-based software applications, the method comprising receiving input from the environment as state information; receiving additional input from at least one of forecast IDs, skill IDs and parameter values; and outputting a forecast for each of the additional input.

Embodiments of the present invention also provide a forecast network method of creating artificial intelligence in machines and computer-based software applications, the method comprising receiving input from the environment as state information; receiving additional input from at least one of forecast IDs, skill IDs and parameter values; embedding the additional input into a learned reduced vector representation before being inputted to the forecast network; and outputting a forecast for each learned reduced vector representation.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1A illustrates multi-headed forecast network according to an exemplary embodiment of the present invention;

FIG. 1B illustrates an example of weighting of input nodes of a neural network;

FIG. 2 illustrates a multi-input forecast network according to an exemplary embodiment of the present invention;

FIG. 3 illustrates a multi-skill forecast network according to an exemplary embodiment of the present invention;

FIG. 4 illustrates a parameterized-skill forecast network according to an exemplary embodiment of the present invention;

FIG. 5 illustrates a hybrid skill IDs and multi-forecast network according to an exemplary embodiment of the present invention; and

FIG. 6 illustrates embeddings with forecast IDs, in a multi-forecast network according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a graphics processing unit (GPU); a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, handheld devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Python, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, an EEPROM or any other memory chip or cartridge, a carrier wave as described hereinafter, or any other medium from which a computer can read.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CDROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer readable media.

While a non-transitory computer-readable medium includes, but is not limited to, a hard drive, compact disc, flash memory, volatile memory, random access memory, magnetic memory, optical memory, semiconductor-based memory, phase change memory, optical memory, periodically refreshed memory, and the like; the non-transitory computer readable medium, however, does not include a pure transitory signal per se; i.e., where the medium itself is transitory.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device. A “computing platform” may comprise one or more processors.

The term “robot” or “agent” or “intelligent agent” or “artificial agent” or “artificial intelligent agent” may refer to any system controlled directly or indirectly by a computer or computing system that issues actions or commands in response to senses or observations. The term may refer without limitation to a traditional physical robot with physical sensors such as cameras, touch sensors, range sensors, and the like, or to a simulated robot that exists in a virtual simulation, or to a “bot” such as a mailbot or searchbot that exists as software in a network. It may without limitation refer to any limbed robots, walking robots, industrial robots (including but not limited to robots used for automation of assembly, painting, repair, maintenance, etc.), wheeled robots, vacuum-cleaning or lawn-mowing robots, personal assistant robots, service robots, medical or surgical robots, flying robots, driving robots, aircraft or spacecraft robots, or any other robots, vehicular or otherwise, real or simulated, operating under substantially autonomous control, including also stationary robots such as intelligent household or workplace appliances.

Many practical embodiments of the present invention provide means and methods for efficient performance of activities by an artificial intelligent agent.

In some embodiments, a “sensor” may include, without limitation, any source of information about an agent's environment, and, more particularly, how a control may be directed toward reaching an end. In a non-limiting example, sensory information may come from any source, including, without limitation, sensory devices, such as cameras, touch sensors, range sensors, temperature sensors, wavelength sensors, sound or speech sensors, proprioceptive sensors, position sensors, pressure or force sensors, velocity or acceleration or other motion sensors, etc., or from compiled, abstract, or situational information (e.g. known position of an object in a space) which may be compiled from a collection of sensory devices combined with previously held information (e.g. regarding recent positions of an object), location information, location sensors, and the like.

The terms “observation” or “observations” refers to any information the agent receives by any means about the agent's environment or itself. In some embodiments, that information may be sensory information or signals received through sensory devices, such as without limitation cameras, touch sensors, range sensors, temperature sensors, wavelength sensors, sound or speech sensors, position sensors, pressure or force sensors, velocity or acceleration or other motion sensors, location sensors (e.g., GPS), etc. In other embodiments that information could also include without limitation compiled, abstract, or situational information compiled from a collection of sensory devices combined with stored information. In a non-limiting example, the agent may receive as observation abstract information regarding the location or characteristics of itself or other objects. In some embodiments this information may refer to people or customers, or to their characteristics, such as purchasing habits, personal contact information, personal preferences, etc. In some embodiments, observations may be information about internal parts of the agent, such as without limitation proprioceptive information or other information regarding the agent's current or past actions, information about the agent's internal state, or information already computed or processed by the agent.

The term “action” refers to the agent's any means for controlling, affecting, or influencing the agent's environment, the agent's physical or simulated self or the agent's internal functioning which may eventually control or influence the agent's future actions, action selections, or action preferences. In many embodiments the actions may directly control a physical or simulated servo or actuator. In some embodiments the actions may be the expression of a preference or set of preferences meant ultimately to influence the agent's choices. In some embodiments, information about the agent's action(s) may include, without limitation, a probability distribution over the agent's action(s), and/or outgoing information meant to influence the agent's ultimate choice of action.

The term “state” or “state information” refers to any collection of information regarding the state of the environment or agent, which may include, without limitation, information about the agent's current and/or past observations.

The term “policy” refers to any function or mapping from any full or partial state information to any action information. Policies may be hard coded or may be modified, adapted or trained with any appropriate learning or teaching method, including, without limitation, any reinforcement-learning method or control optimization method. A policy may be an explicit mapping or may be an implicit mapping, such as without limitation one that may result from optimizing a particular measure, value, or function. A policy may include associated additional information, features, or characteristics, such as, without limitation, starting conditions (or probabilities) that reflect under what conditions the policy may begin or continue, termination conditions (or probabilities) reflecting under what conditions the policy may terminate.

The term “distance” refers to any monotonic function. In some embodiments, distance may refer to the space between two points on a surface as determined by a convenient metric, such as, without limitation, Euclidean distance or Hamming distance. Two points or coordinates are “close” or “nearby” when the distance between them is small.

Broadly, embodiments of the present invention provide methods and systems for training and/or operating an artificial intelligent agent. Multi-forecasts are computational constructs, typically, but not necessarily, neural networks, whose shared network weights can be used to compute multiple related forecasts. This allows for more efficient training, in terms of the amount of data and/or experience needed, and in some instances, for more efficient computation of those forecasts. There are several related and sometimes composable approaches to multi-forecast networks. The discussion below describes these approaches, referring to the associated Figures.

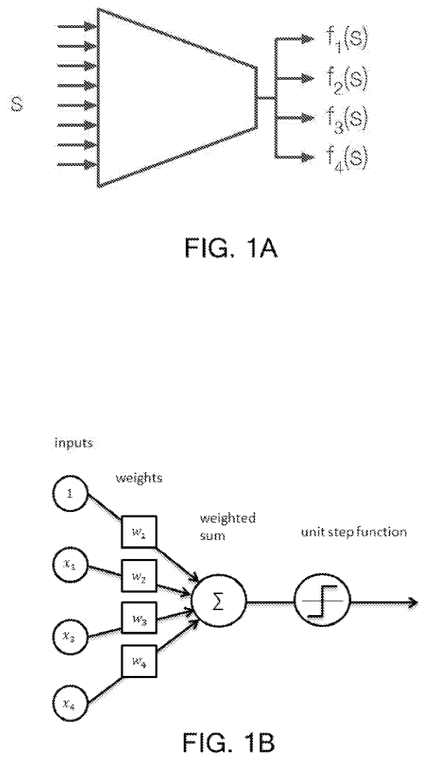

In each of FIGS. 1 through 6, f (x) refers to a forecast where x may be a state, a forecast id, a skill id, a parameter value, or combinations thereof; s refers to a state; g is a forecast id; k is a skill id; and p is a parameter value.

Referring to FIG. 1A, a multi-headed forecast network is shown. Here, a single network has multiple outputs, each output is the forecast of a different feature. The input to the network is the current state, represented by the multiple state inputs, S, shown in FIG. 1. The weights/parameters of the network in all but the last layer of the network are shared among the different forecasts. FIG. 1B illustrates a simple example of weighting, w₁ through w₄, for a set of inputs 1, x₁, x₂ and x₃, for a single activation node in a single hidden layer of a neural network. As can be appreciated, without sharing of weighting, among the different forecasts, the computations can become involved, especially as the neural network grows in the number of hidden layers and activation nodes. Accordingly, there are three benefits from this sharing. First, this sharing can result in faster learning of forecasts. Second, this sharing can result in lower computation cost of computing multiple forecasts because of the shared computation in the lower layers of the network. Third, this sharing can result in a generalization over the state features.

For example, a single multi-headed forecast network could predict the distance, color, shape and weight of the nearest object from a given state. The agent could receive inputs from sensors, or the like, as state input data and could generate forecasts that determine the presence of a blue, round, 3-ounce ball located four feet away at 40 degrees of forward. These forecasts are indicated as f₁(s), f₂(s), f₃(s) and f₄(s) in FIG. 1.

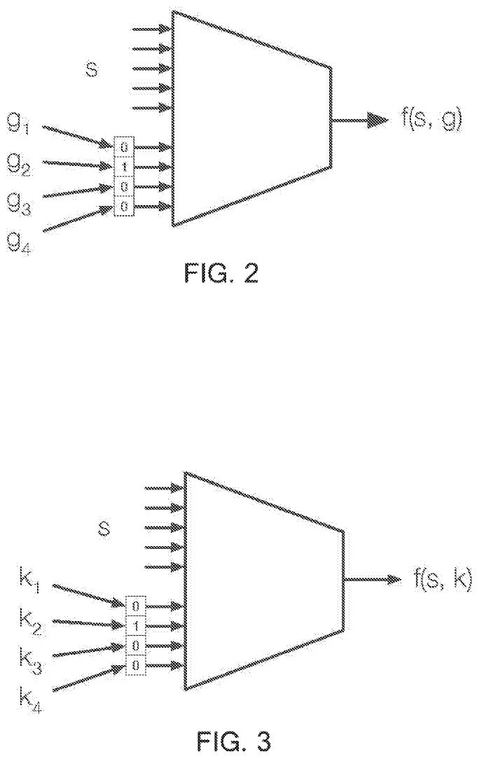

Referring now to FIG. 2, a multi-input forecast network is shown. Here, a single network is capable of computing the value of several different forecasts. It takes the forecast ID, g₁ through g₄, as input in addition to the current state, S. For example, a single network could be able to predict the distance to any of a red, green, blue or yellow block. One can indicate to the network which of the four you would like a prediction for by supplying the vector of g values, where only one of the g values is turned “on”. With g₂=1, as in the drawing, you would be asking the network to compute the distance to the green ball based on the rest of the state information.

The output of the multi-input forecast network is the corresponding forecast value, f(s, g) for the forecast ID supplied as an input. The network is shared, which means the weights/parameters are common across multiple forecasts. There is a significant benefit of parameterized forecasts relative to multi-headed forecasts, namely that the former can generalize to new or untrained-upon forecasts due to the ability of neural networks to generalize to unseen inputs with sufficient training.

For example, such a multi-input forecast network might be capable of predicting the distance, color, shape or weight of an object from an image. The user would supply as an input a flag that tells the network which value should be computed.

Referring to FIG. 3, a multi-skill forecast network is shown. This network is capable of computing the same kind of forecast for different skills. In addition to the state, S, the forecast network takes a skill ID, k₁ through k₄, as an input and outputs the forecast value, f(s, k). The multi-skill forecast network is able to generalize the forecast based on skills that share some common state dependencies.

For example, a multi-skill forecast network could be used to compute the duration of one of the skills, run-to-door, walk-to-door, skip-to-door, or crawl-to-door, all of which are dependent on how far the agent is from the door. Here, like in FIG. 2, the [0,1] layer is meant to represent the “one-hot” nature of the inputs supplied. In the drawing, by setting the second skill (walk-to-door) flag equal to 1, and the rest to zero, you are asking the network to compute the forecast if you performed the walk-to-door skill.

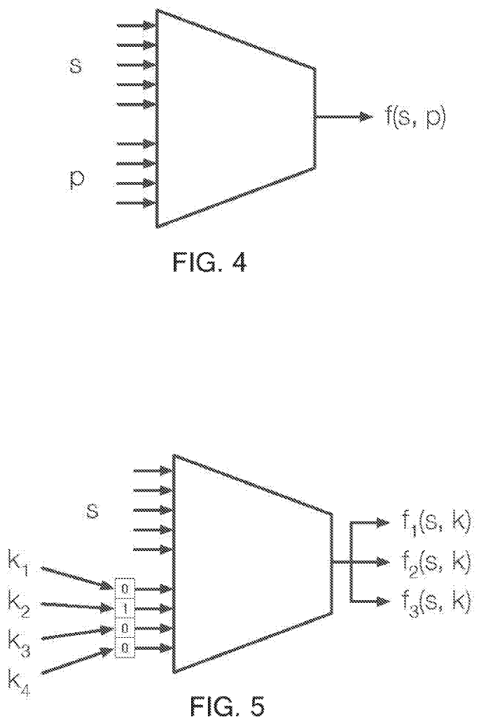

Referring to FIG. 4, a parameterized-skill forecast network is shown. This network is capable of predicting a state feature or other forecast based on a variable input parameter that affects the behavior. For example, the forecast, f(s, p) may predict how far a ball will roll when it is kicked, where the input parameter, p, is how hard to kick the ball, or all of the joint angles planned for the kicking motion.

Referring to FIG. 5, a hybrid network is shown. In the example shown, this network combines the multi-headed forecast of FIG. 1A with one or more of the skill-conditional networks, such as that shown in FIG. 3 or 4. For example, a single network might be able to compute three output forecasts, such as the distance, duration and knee pain experienced, for a set of similar skills, such as run-to-door, walk-to-door, skip-to-door or crawl-to-door. The inputs would include the normal state information as well as encoding of the skill ID.

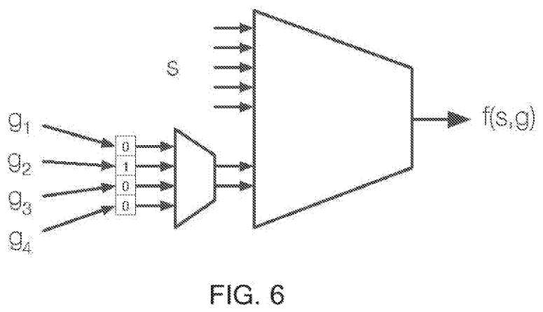

Referring to FIG. 6, embeddings are a technique to force even more generalization across the inputs. Embeddings can be used with any of the conditioning inputs. In FIG. 6, the conditioning inputs are first embedded into a learned reduced vector representation to form in input to the parameterized forecast.

For example, a network that needs to predict duration for run-to-door, walk-to-door, skip-to-door or crawl-to-door may learn to cluster run and skip into one category, and crawl and walk into a second category, and then condition the forecast on those two categories.

It should be noted that many combinations of these networks are possible. For example, one can have a forecast network that is conditioned on both skill IDs and forecast IDs, combining the networks of FIGS. 2 and 3. Or one could combine the networks of FIGS. 1A, 3 and 4 to get a network that can make predictions of several state variable forecasts for a multitude of skills with a common, real valued input parameter, such as the amount of force.

For example, one network could be built that predicts forecasts for the distance, duration and knee pain experienced for four different skills (run, walk, skip and crawl) as well as an “effort” input parameter.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

The particular implementation of the intelligent artificial agents may vary depending upon the particular context or application. By way of example, and not limitation, the intelligent artificial agents described in the foregoing were principally directed to two-dimensional implementations; however, similar techniques may instead be applied to higher-dimension implementation, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

The claims are thus to be understood to include what is specifically illustrated and described above, what is conceptually equivalent, what can be obviously substituted and also what incorporates the essential idea of the invention.

What is claimed is:

1. A multi-headed forecast method of creating artificial intelligence in machines and computer-based software applications, the method comprising:
receiving input from the environment as state information; and
outputting a plurality of forecasts, each of the plurality of forecasts corresponding to a different state information feature.

2. The multi-headed forecast method of claim 1, wherein weights or parameters of the network in all but a last layer of the network are shared among each of the plurality of forecasts.

3. The multi-headed forecast method of claim 1, further comprising minimizing a time required to learn each of the plurality of forecast by sharing, among each of the plurality of forecasts, weights or parameters of the network in all but a last layer of the network.

4. The multi-headed forecast method of claim 1, further comprising minimizing a computational cost of computing the plurality of forecasts by sharing, among each of the plurality of forecasts, weights or parameters of the network in all but a last layer of the network.

5. The multi-headed forecast method of claim 1, further comprising generalizing the state information.

6. The multi-headed forecast method of claim 1, further comprising inputting at least one of a plurality of skill IDs and a plurality of forecast IDs to provide a hybrid network, wherein the plurality of forecasts are output for a set of similar skills or forecasts based, respectively on the plurality of skill IDs and the plurality of forecast IDs.

7. A multi-input forecast method of creating artificial intelligence in machines and computer-based software applications, the method comprising:
receiving input from the environment as state information;
receiving additional input from at least one of forecast IDs, skill IDs and parameter values; and
outputting a forecast for each of the additional input.

8. The multi-input forecast method of claim 7, wherein in the additional input includes a plurality of forecast IDs, wherein the forecast outputted is a forecast value for the forecast ID supplied as an input.

9. The multi-input forecast method of claim 7, wherein weights or parameters of the network are shared across multiple ones of the forecast.

10. The multi-input forecast method of claim 7, wherein the additional input includes a plurality of skill IDs.

11. The multi-input forecast method of claim 10, further comprising generalizing the forecast based on skills that share common state dependencies.

12. The multi-input forecast method of claim 7, wherein the additional input includes a variable input parameter that affects behavior.

13. A forecast network method of creating artificial intelligence in machines and computer-based software applications, the method comprising:
receiving input from the environment as state information;
receiving additional input from at least one of forecast IDs, skill IDs and parameter values;
embedding the additional input into a learned reduced vector representation before being inputted to the forecast network; and
outputting a forecast for each learned reduced vector representation.

14. The forecast network method of claim 13, further comprising outputting a plurality of forecasts, each of the plurality of forecasts corresponding to a different state information feature.

15. The forecast network method of claim 14, wherein weights or parameters of the network in all but a last layer of the network are shared among each of the plurality of forecasts.

16. The forecast network method of claim 14, further comprising inputting at least one of a plurality of skill IDs and a plurality of forecast IDs to provide a hybrid network, wherein the plurality of forecasts are output for a set of similar skills or forecasts based, respectively on the plurality of skill IDs and the plurality of forecast IDs.

17. The forecast network method of claim 13, wherein in the additional input includes a plurality of forecast IDs, wherein the forecast outputted is a forecast value for the forecast ID supplied as an input.

18. The forecast network method of claim 17, wherein weights or parameters of the network are shared across multiple ones of the forecast.

19. The forecast network method of claim 17, wherein the additional input includes a plurality of skill IDs.

20. The forecast network method of claim 19, further comprising generalizing the forecast based on skills that share common state dependencies.
